(19) United States
(12) Patent Application Publication
(10) Pub. No.: US 2024/0326751 A1
(43) Pub. Date: Oct. 3, 2024

(54) WIPER FOR A DEVICE FOR WIPING A GLAZED SURFACE OF A VEHICLE, IN PARTICULAR A MOTOR VEHICLE

(71) Applicant: VALEO SYSTÈMES D'ESSUYAGE, LE MESNIL SAINT DENIS (FR)

(72) Inventors: Vincent Izabel, LE MESNIL SAINT DENIS (FR); Alexandre Filloux, LE MESNIL SAINT DENIS (FR); Frederic Giraud, LE MESNIL SAINT DENIS (FR); Gérald Caillot, LE MESNIL SAINT DENIS (FR); Jean Michel Jarasson, LE MESNIL SAINT DENIS (FR)

(73) Assignee: VALEO SYSTÈMES D'ESSUYAGE, LE MESNIL SAINT DENIS (FR)

(21) Appl. No.: 18/293,344

(22) PCT Filed: Jul. 29, 2022
(86) PCT No.: PCT/EP2022/071470

§ 371 Date: Jan. 29, 2024

(30) Foreign Application Priority Data
Jul. 30, 2021 (FR) 2108348
Jul. 30, 2021 (FR) 2108355

(51) Int. Cl. B60S 1/52; B60S 1/38; B60S 1/48

(52) U.S. Cl. CPC B60S 1/524; B60S 1/381; B60S 1/482

(57) ABSTRACT

A wiper blade is disclosed having a blade body extending along a longitudinal elongation direction of the wiper blade and a wiper rubber carried by the blade body and configured for cleaning a visibility zone of a glazed surface for a motor vehicle. The blade body includes at least one spray element configured to project the cleaning fluid into an additional zone separate from the visibility zone to clean an element arranged outside the visibility zone. The at least one spray element is in a so-called vertical orientation defined by an angle between 60° and 110° with respect to a so-called vertical direction substantially perpendicular to the longitudinal elongation direction and in a so-called vertical plane, of which the normal is parallel to the main elongation direction.

The present invention relates to the field of wiper devices for vehicles, in particular motor vehicles. More particularly, the invention relates to a wiper device configured to project a cleaning fluid both over a visibility zone of a glazed surface of the vehicle and over a portion of the vehicle arranged outside said glazed surface.

Visibility through the glazed surfaces of a vehicle is an essential element for a user to be able to safely drive the vehicle. Depending on the environmental conditions, these glazed surfaces become soiled more or less quickly, resulting in a deterioration of visibility through these glazed surfaces.

In order to at least partially clean the soiled glazed surfaces, the vehicle is provided with at least one wiper device, associated with one of the glazed surfaces of the vehicle, which may comprise one or more wiper blades in contact with the glazed surfaces. The wiper blades are driven in rotation in a reciprocating movement between an original position and an end-of-travel position which generally faces a window pillar of the glazed surface. The surface traveled by the wiper blade(s) between the original position and the end-of-travel position is also referred to as the visibility zone, this visibility zone consisting of the part of the glazed surface which is legally required to be kept clean.

In addition, vehicles increasingly comprise driver assistance systems for assisting with driving the vehicle, and therefore sensors associated with these systems. By way of example, driver assistance systems may consist in particular of reversing assistance systems, inter-vehicle distance regulation systems, systems for detecting traffic signs, blind spot warning systems, etc. These sensors are arranged on and in the vehicle depending on the driver assistance system concerned. For example, they may be arranged in or behind the glazed surface of the vehicle, at the level of the visibility zone, and cleaning thereof may then be carried out by the wiper device.

Sensors may also be arranged at the level of the vehicle window pillar. By way of example, these sensors can be cameras that film the portion of the road hidden from the driver by the presence of a window pillar, the acquired images then being able to be projected onto an internal face of the window pillar concerned or else processed to send an alert in the event of detection of an obstacle in the blind spot. These sensors are then completely out of reach of the wiper device even if the wiper blade moves to the end-of-travel position facing the window pillar. The washing of the sensors thus arranged then requires having a cleaning system dedicated to each sensor. By way of example, an air jet washing device may be arranged in the vicinity of the sensor and may be actuated at regular intervals and/or whenever too much dirt is detected on the sensor.

This solution has the disadvantage of multiplying the number of cleaning systems to be installed in a vehicle and of increasing the cost of driver assistance systems.

Another disadvantage is the need to have a cleaning fluid supply for each of the cleaning systems. It is then necessary to create a system of complex ducts and in particular to manage the pressure drops within said ducts.

The object of the present invention is to overcome at least one of the aforementioned disadvantages and also to lead to other advantages by proposing a new type of wiper device for a vehicle, in particular a motor vehicle.

The invention relates to a wiper blade comprising a blade body extending along a longitudinal elongation direction of the wiper blade and a wiper rubber carried by the blade body and configured for cleaning a visibility zone of a glazed surface for a vehicle, in particular a motor vehicle, the blade body comprising:
at least one spray element configured to project the cleaning fluid into an additional zone separate from the visibility zone so as to be able to clean an element arranged outside the visibility zone,
the at least one spray element has a so-called vertical orientation defined by an angle between 60° and 110° with respect to a so-called vertical direction substantially perpendicular to the longitudinal elongation direction and in a so-called vertical plane, of which the normal is parallel to the main elongation direction.

By virtue of these arrangements, the spray element is able to project fluid into the additional zone separate from the visibility zone.

It will be understood that the additional zone is further away from the blade than the visibility zone.

In some embodiments, the angle defining the vertical orientation is between 60° and 100°.

In some embodiments, the angle defining the vertical orientation is between 80° and 100°.

In some embodiments, the angle defining the vertical orientation is between 70° and 90°.

In some embodiments, the blade comprises at least one spray orifice configured to project cleaning fluid substantially into the visibility zone.

In some embodiments, the at least one spray orifice has a vertical orientation different from the vertical orientation of the at least one so-called additional spray element.

In some embodiments, the wiper blade comprises at least one tubular portion delimiting within it a circulation channel for the cleaning fluid, the tubular portion being able to be connected to a cleaning fluid supply device for the wiper blade, the at least one spray orifice being formed in the tubular portion and opening into the circulation channel.

The cleaning fluid circulation channel may be delimited by a tubular portion of the blade body. The circulation channel is able to be connected to the cleaning fluid supply device for the wiper blade in such a way that the fluid is conveyed from the supply device to the at least one spray orifice and to the at least one additional spray element.

The at least one spray orifice may be formed in the tubular portion.

It will be understood that the at least one spray orifice opens into the circulation channel.

It will be understood that the at least one additional spray element has a defined orientation with respect to a specific axis or plane of the wiper blade which is different from an orientation of the at least one spray orifice.

The at least one spray orifice and the additional spray element may consist of holes drilled in the blade body and delimited by material constituting the blade body.

For example, the blade body comprises a series of spray orifices, including the at least one spray orifice. The series of spray orifices is configured to project the cleaning fluid into the visibility zone.

The spray orifices are configured to have a substantially equivalent orientation from one spray orifice to another, a mean orientation of the spray orifices being defined with respect to a specific axis or plane of the wiper blade.

Each spray orifice of the series of spray orifices and the additional spray element may consist of holes drilled in the blade body and delimited by material constituting the blade body.

The spray orifices form a wiper device on the blade, which allows a projection of fluid that follows the movement of the blade, such as may be known for example under the brand name Aquablade, and the additional spray element(s) are specific to the invention in that they propose second spray means different from the spray orifices in order to generate a specific projection of cleaning fluid.

The orientation of at least one spray orifice is defined by an axis of elongation passing through the center of the passage cross section at the junction of the spray orifice and of the circulation channel and through the center of the passage cross section at the junction between the spray orifice and the outer surface of the blade body. This axis of elongation may in particular be an axis of revolution of the corresponding orifice.

The axes of elongation of each of the spray orifices of the series of spray orifices are substantially parallel to one another and not coincident. A mean orientation, or mean axis of elongation, of the spray orifices is defined to take into account any deviation of a few degrees or tenths of degrees that there may be from parallelism of one axis of elongation of the spray orifice to another due to manufacturing tolerances.

The spray orifices forming the first spray means are arranged on one and the same supply channel and are configured so that cleaning fluid circulating in this supply channel simultaneously exits through each of the spray orifices of the series of spray orifices to spray the visibility zone over all or part of the longitudinal dimension of the blade.

The axis of elongation of the at least one additional spray element may be defined in an equivalent manner to that described for the at least one spray orifice and the axis of elongation of each spray element is particular in that it has an orientation which differs from the mean orientation of the axes of elongation of the spray orifices. In other words, the cleaning fluid exiting from an additional spray element has a main ejection direction that is different from that taken by the cleaning fluid when exiting from a spray orifice of the series of spray orifices.

It will be understood in this context that the wiper blade can project a cleaning fluid into the visibility zone, via the at least one spray orifice of the and outside the visibility zone, via the at least one additional spray element.

According to one embodiment, the blade body comprises a deflector mounted on the wiper rubber and at least one end piece arranged at one of the longitudinal ends of the deflector so as to hold the air-deflecting element and the wiper rubber together. For example, the blade body comprises two end pieces each arranged at one or other of the longitudinal ends of the deflector. Thus, the wiper rubber is locked in position along the longitudinal axis of the wiper blade. It will be understood that the deflector and the end pieces are to be considered as separate parts.

For example, the at least one spray orifice and the at least one additional spray element are formed in the deflector. For example, the at least one end piece has no spray orifice and no additional spray element.

According to one feature of the invention, the circulation channel is formed in the deflector. It will be understood that, according to this embodiment, all the components allowing the circulation and the projection of fluid are formed in the deflector.

For example, at least the at least one spray orifice and/or the at least one additional spray element is/are formed in the at least one end piece.

For example, the at least one additional spray element is formed in the end piece forming the longitudinal end of the blade body intended to be on the upper side of the windshield.

According to one feature of the invention, each additional spray element is formed in the blade body so as to be in fluidic communication with the same circulation channel as the circulation channel with which the at least one spray orifice is in fluidic communication.

According to one feature of the invention, the wiper blade comprises an additional tubular portion delimiting an additional circulation channel for cleaning fluid within the blade body, the additional tubular portion being connected to the supply device, and the at least one additional spray element is in fluidic communication with the additional circulation channel. Thus, the at least one spray orifice and the at least one additional spray element are respectively connected to their own circulation channel, the circulation channels being formed independently of one another in the blade body.

According to one feature of the invention, the blade body comprises a deflector, the tubular portion or portions, the series of spray orifices and the at least one additional spray element being formed in the deflector. It will be understood that, according to this embodiment, all the components allowing the circulation and the projection of fluid are formed in the deflector and in particular the two tubular portions, when an additional tubular portion is provided.

According to one feature of the invention, the deflector comprises an air-deflecting element and a wiper rubber support.

The deflector comprises a projection allowing the blade to be pressed against the window when the blade is subjected to a current of air coming from the front of the vehicle when the blade is mounted on the vehicle. The projection may be part of the air-deflecting element.

The circulation channel, the at least one spray orifice and/or the at least one additional spray element may be formed in the support.

The wiper rubber support may in particular be configured to support the wiper rubber, and may further comprise housings for receiving one or more stiffening vertebrae.

It will be understood that, according to this embodiment, all or some of the components allowing the circulation and the projection of fluid may be formed in the wiper rubber support.

According to one feature of the invention, the mean orientation of the at least one spray orifice differs from the orientation of the at least one additional spray element seen in projection in a plane substantially perpendicular to the longitudinal elongation direction of the wiper blade, that is to say in a longitudinal and transverse cutting plane of the blade. In other words, the vertical orientation of the additional spray element differs from the vertical orientation of the at least one spray orifice, so as to project, for a given position of the body of the blade, the cleaning fluid at different distances. More particularly, the vertical orientation of the additional spray element forms a flatter angle, i.e. one closer to a longitudinal and transverse plane, than the vertical orientation of the at least one spray orifice, in order to be able to project the cleaning fluid further by the at least one additional spray element. For example, the vertical orientation of the at least one additional spray element is defined by an angle between −30° and 10° with respect to a transverse direction perpendicular to the longitudinal direction.

According to one feature of the invention, the orientation of the at least one spray orifice differs from the orientation of the additional spray element seen in projection in a longitudinal and transverse cutting plane of the blade, that is to say seen in projection on a plane perpendicular to a longitudinal median plane of the wiper rubber and comprising the longitudinal elongation direction of the wiper blade. In other words, in a plane substantially parallel to the glazed surface to be cleaned, the longitudinal orientation of the at least one additional spray element is, in particular, further apart than the longitudinal orientation of the at least one spray orifice, to allow cleaning fluid to be projected onto the sides of the blade.

In some embodiments, the at least one additional spray element is configured to project cleaning liquid when a threshold pressure is reached by the cleaning liquid in the circulation channel.

According to one feature of the invention, a passage cross section of the at least one spray orifice is larger than a passage cross section of the at least one additional spray element. In accordance with what has been mentioned above, a mean passage cross section of the spray orifices of the series of spray orifices is defined in order to take account of possible manufacturing tolerances from one spray orifice to another.

According to one feature of the invention, the passage cross section of the additional spray element is smaller than each of the passage cross sections of the spray orifices of the series of spray orifices.

Thus, at a first pressure of the cleaning fluid circulating in the circulation channel and imposed by the supply device, the at least one spray orifice allows the projection of cleaning fluid, whereas the additional spray element, on account of its passage cross section being smaller than the passage cross section of the spray orifices of the series of spray orifices, cannot allow it. Only the visibility zone receives cleaning fluid, via the at least one spray orifice.

When the supply device imposes a second cleaning fluid pressure which is greater than the first pressure mentioned above, the at least one spray orifice still allows the projection of cleaning fluid into the visibility zone, but the additional spray element can now also project cleaning fluid, which then makes it possible to reach a zone outside the visibility zone.

According to one feature of the invention, the additional spray element is equipped with a valve configured to open only under a defined cleaning fluid pressure. Such a device makes it possible to project fluid via the additional spray element, that is to say outside the visibility zone onto sensors present on the window pillars, only when the cleaning fluid is sent into the corresponding circulation channel under a certain pressure.

In some embodiments, the at least one additional spray element comprises at least one closure element for closing the passage cross section, the closure element being configured to occupy a closure position, closing the passage cross section when the pressure in the circulation channel is less than the threshold pressure, and an open position, allowing the cleaning liquid to be projected via the additional spray element when the pressure in the circulation channel is greater than or equal to the threshold pressure.

In some embodiments, the at least one closure element is configured to pass from the closure position to the open position by elastic deformation. According to one feature of the invention, the wiper blade comprises a plurality of additional spray elements arranged on the blade body and distributed along the longitudinal elongation direction of the wiper blade. In this context, two additional spray elements, between which spray orifices are arranged, each have an orientation different from the mean orientation of the spray orifices of the series of spray orifices and the orientations of these two additional spray elements are different from one another. Alternatively or additionally, two adjacent additional spray elements, without spray orifices interposed between them, each have an orientation different from the mean orientation of the spray orifices of the series of spray orifices and the orientations of these two additional spray elements are substantially equivalent. In other words, the additional spray elements which are arranged in different places on the blade body are intended to project cleaning fluid onto zones of the window pillar which are remote from one another, and these additional spray elements have their own orientation to ensure this projection onto a specific zone, whereas the additional spray elements which are side by side participate in projecting fluid onto one and the same zone of the pillar and may therefore have similar orientations, provided that this common orientation is different from the mean orientation of the spray orifices of the series of spray orifices.

The invention also relates to a device for wiping a glazed surface for a vehicle, in particular a motor vehicle, comprising at least one wiper blade for wiping the glazed surface as described above, the at least one spray orifice being configured to project the cleaning fluid into the visibility zone formed by the cleaning zone of the wiper rubber, and the at least one additional spray element being configured to project the cleaning fluid outside the visibility zone so as to permit the cleaning of at least one element arranged outside the visibility zone.

The wiper device may in particular comprise at least one arm for driving the wiper blade that is configured so that the wiper blade rubs against the glazed surface and at least one cleaning fluid supply device for the wiper blade.

According to one embodiment, the element arranged outside the visibility zone is a sensor.

According to one embodiment, the element arranged outside the visibility zone is arranged on or in the vicinity of a pillar of the vehicle participating in delimiting the glazed surface. It should be understood here that the element arranged outside the visibility zone and capable of being cleaned by the wiper blade specific to the invention may be arranged on a side window pillar, participating in laterally delimiting the glazed surface, or on the edge of the roof of the vehicle participating in vertically delimiting the glazed surface. The expression in the vicinity of a pillar should be understood as meaning that the element may be on or behind the glazed surface, in any position in which the element is not wiped by a conventional wiper system.

For example, the element arranged outside the visibility zone is arranged in a high central position of the windshield. For example, the element arranged outside the visibility zone may be formed with the windshield, or may comprise a separate surface.

According to one embodiment, the wiper blade is movable between a rest position and an end-of-travel position, the wiper device being configured to project the cleaning fluid outside the visibility zone via the additional spray element when the wiper blade is in a predetermined position or in a predetermined angular sector. The predetermined position may be, for example, the end-of-travel position which faces a window pillar of the vehicle, and in which the longitudinal axis of the blade is substantially parallel to the window pillar. The angular sector may be defined as a function of the position and width of the element arranged outside the visibility zone.

The invention also aims to protect a vehicle, in particular a motor vehicle, comprising at least one glazed surface and at least one wiper blade having at least one of the preceding features.

Other features and advantages of the invention will also become apparent from the following description, on the one hand, and from several exemplary embodiments given by way of nonlimiting indication with reference to the attached schematic drawings, on the other hand, in which drawings:

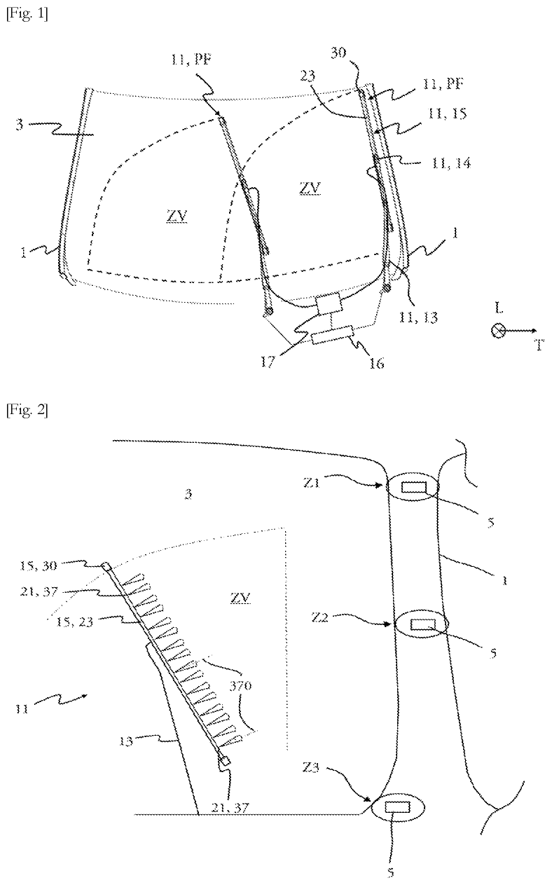

FIG. 1 is a schematic representation of a glazed surface, held in position laterally by two vehicle window pillars, and a device for wiping the glazed surface;

FIG. 2 is a schematic representation of a blade of the wiper device of FIG. 1 in operation, the blade wiping the visibility zone and the spray orifices projecting fluid onto the visibility zone;

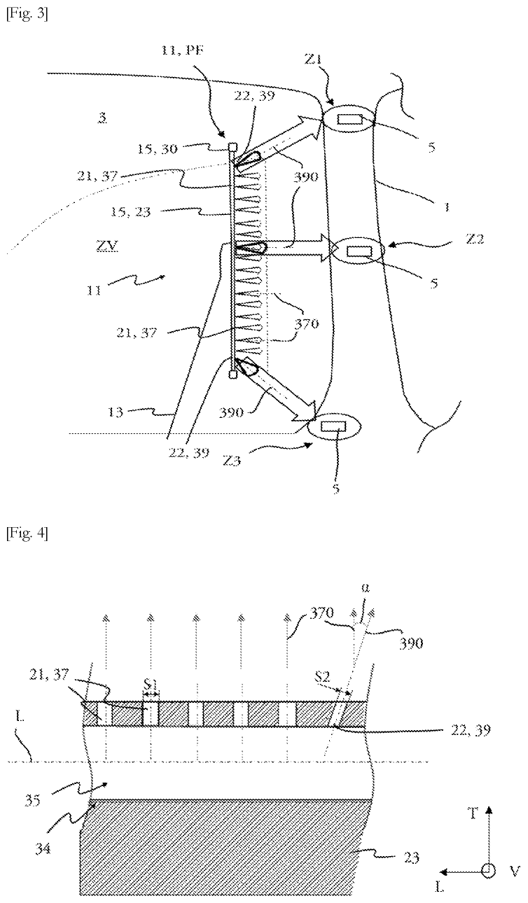

FIG. 3 is a schematic representation of a blade of the wiper device of FIG. 1 in operation, the blade facing one of the window pillars and two types of fluid projection being operational, one to cover a visibility zone on the glazed surface and the other to reach the window pillar;

FIG. 3 is a partial schematic representation of the body of the blade, seen in section along a plane substantially parallel to that of the glazed surface, making visible a characteristic of particular orientation of a fluid spray orifice according to one aspect of the invention;

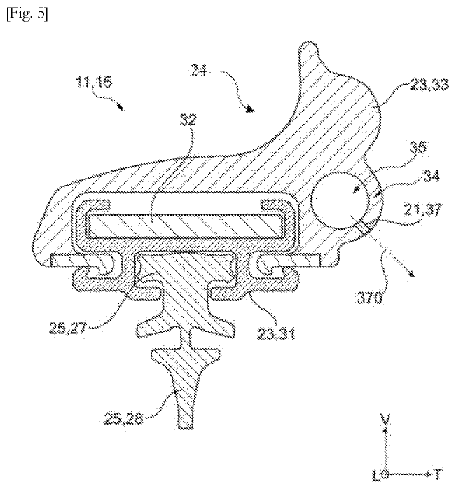

FIG. 5 is a schematic representation of the blade in its entirety, seen in section along a plane perpendicular to that of the glazed surface and perpendicular to the main elongation direction of the blade;

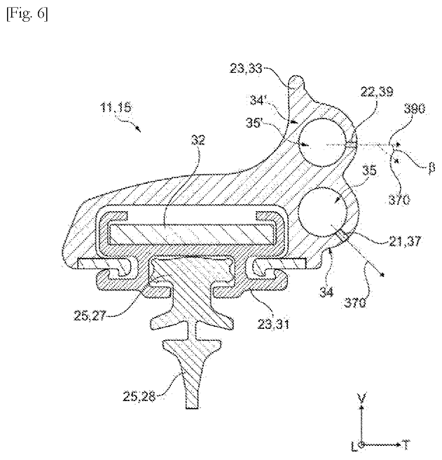

FIG. 6 is a view similar to that of FIG. 4 illustrating a blade according to a second embodiment of the invention;

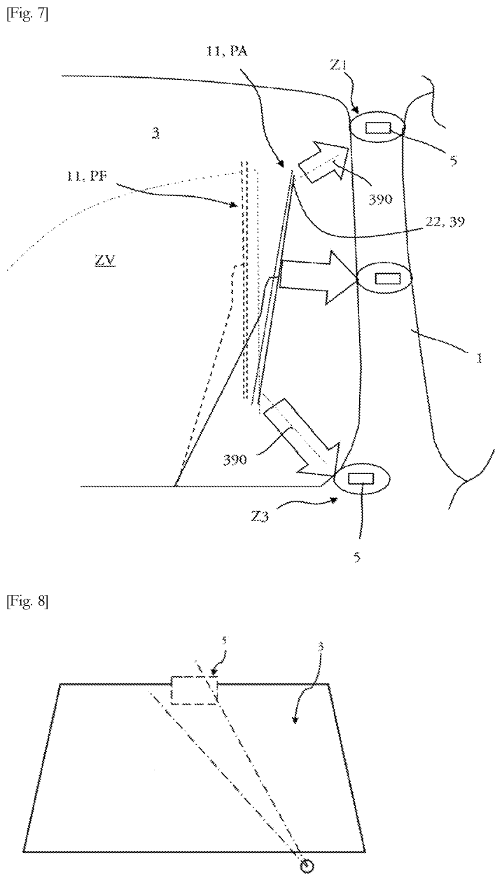

FIG. 7 is a schematic representation of a blade of the wiper device of FIG. 1 in operation, the blade facing one of the window pillars and one type of fluid projection being operational, to reach the window pillar;

FIG. 8 is a schematic representation of a glazed surface;

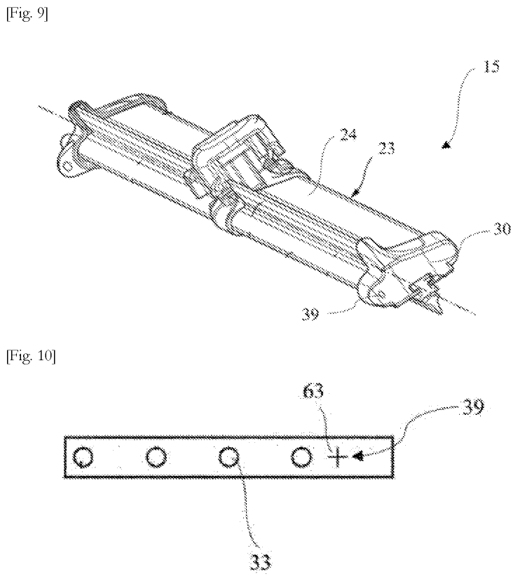

FIG. 9 is a representation of the blade comprising an additional spray element in the end piece;

FIG. 10 is a schematic representation of the spray orifices of an additional spray element according to one embodiment.

It should first of all be noted that, although the figures set out the invention in detail for its implementation, they may, of course, be used to better define the invention if necessary. It should also be noted that, in all of the figures, elements that are similar and/or perform the same function are indicated by the same numbering.

In what follows, the terms longitudinal, vertical and transverse relate to the wiper blade suitable for equipping the wiper device according to the invention, independently of the position of this blade and of the wiper device on the motor vehicle and the glazed surface that it is intended to clean. More particularly, the longitudinal direction corresponds to the main elongation direction of the blade, the vertical direction corresponds to the stacking direction of the body of the blade and of the rubber forming the main components of the blade and the transverse direction being perpendicular to these two longitudinal and vertical directions.

FIG. 1 schematically illustrates window pillars 1 of a vehicle which are arranged laterally on either side of a glazed surface 3.

The glazed surface 3 makes it possible to protect a passenger compartment of the vehicle as well as any occupants thereof from environmental conditions such as wind, rain or even the projection of foreign bodies. Detectors can be placed in the passenger compartment behind the glazed surface 3 or be integrated directly into it. The detector may be, for example, a LIDAR or a rain detector or even a camera.

In the example illustrated, the glazed surface 3 is a front windshield and the window pillars are front pillars of the vehicle. Alternatively, the glazed surface may be a rear window of the vehicle or a side window of the vehicle, the window pillars then being able to be rear pillars or side pillars of the vehicle.

With reference to FIG. 1, at least one sensor 5 is arranged on one of the window pillars 1 holding the glazed surface 3. The sensor 5 may be part of a driver assistance system configured to facilitate vehicle maneuvers and/or increase vehicle safety. The sensor 5 is, for example, an optical sensor, a camera, a LIDAR system, a radar system or even an ultrasonic rangefinder.

In the example shown in the figures, the vehicle comprises a plurality of sensors 5 respectively arranged on one of the window pillars 1 surrounding the windshield of the vehicle and which will subsequently be referred to as the front window pillar 1 of the vehicle. The sensors are arranged in different zones of this front window pillar and more particularly in this case in three zones Z1, Z2, Z3. Each zone Z1, Z2, Z3 is at a nonzero distance from the other zones.

According to another embodiment, shown in FIG. 8, the sensor 5 may be arranged at least partially above the glazed surface 3, for example in a central position relative to the latter.

The vehicle comprises at least one wiper device 11 for wiping the glazed surface 3. The wiper device 11 comprises at least one arm 13 and at least one wiper blade 15 attached to the arm 13 via a connector 14. The arm 13 is configured to perform a reciprocating movement which may be linear and/or angular, this movement being controlled by an electronic management system 16 of the wiper device. The wiper device 11 is configured so that the blade 15 is pressed against the glazed surface throughout the reciprocating movement of the arm 13.

The displacement of the arm 13 and of the wiper blade 15 is effected between two end-of-travel positions, including a first end-of-travel position and a second end-of-travel position PF.

The first end-of-travel position is located in the vicinity of the hood of the car. The first end-of-travel position may for example correspond to a rest position when the wiper device 11 is not in use and the blade is at least partially retracted under the upper part of the front hood of the vehicle. The second end-of-travel position PF is located in the vicinity of one of the window pillars 1 of the car.

As can be seen in FIGS. 2 and 3 in particular, the passage of the blade from the first end-of-travel position and the second end-of-travel position defines a visibility zone ZV that the wiper device 11 must keep clean for safe driving.

The wiper device 11 comprises a cleaning fluid supply device 17 and spray means 19 mounted on the blade of the wiper device and configured to project the cleaning fluid onto the glazed surface and/or outside the glazed surface. More particularly, according to the invention, the wiper blade 15 of the wiper device comprises first spray means 21 which are configured to project the cleaning fluid into the visibility zone ZV, and second spray means 22 which are configured to project the cleaning fluid outside the visibility zone and in particular onto one of the front window pillars 1.

In the example illustrated, the wiper blade 15 extends mainly along a longitudinal axis L and it comprises a blade body 23 and a wiper rubber 25 carried by this blade body 23. The wiper rubber 25 has in particular a heel 27 able to be housed in a receiving cavity formed in the blade body 23, and a lip 28 intended to be in contact with the glazed surface to be cleaned. The wiper rubber 25 makes it possible to define a vertical direction V of the blade, this vertical direction corresponding to the direction of extension of the blade from the lip to the heel, and in this way to define a vertical direction perpendicular to the longitudinal direction and to the transverse direction.

The blade body 23 comprises a deflector 24 and, at its longitudinal ends, end pieces 30 which are configured to hold the deflector 24 and the wiper rubber 25 together.

The deflector 24 mainly comprises a support 31, in which is formed the receiving cavity for receiving the heel of the wiper rubber 25, and an air-deflecting element 33. For example, the cleaning fluid spray means mentioned above, both the first and the second means, are carried by the deflector 24, that is to say either by the support 31 or by the air-deflecting element 33, or by one of the end pieces, as shown in FIG. 9. In the examples illustrated, the spray means are formed in the air-deflecting element 33, but it should be understood that, without departing from the context of the invention, the volume of the support 31 could be greater than that of the air-deflecting element and allow the spray means to be carried by the support rather than by the air-deflecting element.

The support 31 is configured to carry the wiper rubber, to house at least one stiffening vertebra 32, the flexibility of which makes it possible to press the blade and the wiper rubber against the glazed surface, and to allow the air-deflecting element 33 to be held.

The fluid spray means are made in the blade body 23 so as to communicate fluidically with at least one tubular portion 34 delimiting within it a circulation channel 35 for the cleaning fluid, the tubular portion 34 being connected to the supply device 17.

The spray means comprise at least one series of spray orifices 37 for the cleaning liquid which is configured to spray the cleaning fluid substantially into the visibility zone, forming the first spray means 21 mentioned above. And they further comprise at least one additional spray element 39, forming the second spray means 22, which has a particular configuration, at least in its orientation with respect to a mean orientation of the spray orifices of the series of spray orifices forming the first spray means.

This particular configuration will be described in greater detail hereinafter, with reference to FIGS. 4 to 6 in particular. Firstly, the function of this particular configuration will be described with reference to FIGS. 2 and 3.

FIG. 2 illustrates the wiper device during its reciprocating movement, in an intermediate position between the first end-of-travel position and the second end-of-travel position, whereas FIG. 3 illustrates the wiper device in the second end-of-travel position, facing the window pillar in which sensors are arranged.

These figures further illustrate the visibility zone defined on the glazed surface by the passage of the blade between the two end-of-travel positions, as well as the zones Z1 to Z3 in which sensors present in the window pillar are arranged.

The electronic management system 16 of the wiper device and the supply device 17 are configured to send the fluid into the additional spray means in an optimized manner according to the driving conditions and, where appropriate, the cleaning needs of the elements. More particularly, the electronic management system is configured to integrate the vehicle speed and wiper system speed parameters to define the optimal control of the additional spray means.

By way of example, the electronic management system 16 of the wiper device and the supply device 17 are configured so that, during the movement of the blade toward the second end-of-travel position PF, the cleaning fluid is projected by the first spray means 21, that is to say the spray orifices of the series of spray orifices 37, onto the visibility zone ZV, upstream of the passage of the blade. In the various intermediate positions which follow one another until reaching the second end-of-travel position PF, only the first spray means 21 are capable of projecting cleaning fluid. The jets leaving the spray orifices 37 extend mainly perpendicularly to the blade of the wiper device 11, and at a defined distance from the blade, upstream of the passage of the blade and in the visibility zone, so that the cleaning fluid is then wiped by the passage of the blade. The spray orifices 37 of the series of spray orifices 37 are arranged on one and the same circulation channel 35 and are configured so that cleaning fluid circulating in this circulation channel 35 simultaneously exits through each of the spray orifices 37 of the series of spray orifices 37 to spray the visibility zone over the entire longitudinal dimension of the blade. It should be noted that it is detrimental at this stage to project cleaning fluid through the additional spray element(s) 39, since the cleaning fluid would not reach the window pillar and the zones in which the sensors are arranged, and since this fluid would be projected outside the visibility zone and not directly wiped by the passage of the blade. Unnecessary consumption of cleaning fluid would result.

According to the invention, the electronic management system 16 of the wiper device and the supply device 17 are configured such that when the blade is in the second end-of-travel position PF or when the blade is close to this second end-of-travel position, the cleaning fluid can be projected this time by the second spray means 22, that is to say the additional spray element(s) 39. In the example illustrated, cleaning fluid is also projected simultaneously by the first spray means 21, that is to say the spray orifices 37 of the series of spray orifices 37. Without departing from the context of the invention, it could be provided that the spray orifices are equipped with a device for blocking the passage of fluid, which is activated in this second end-of-travel position so that only the second spray means 22 are capable of projecting cleaning fluid.

As illustrated, the jets leaving the additional spray elements 39 extend in a direction different from the direction perpendicular to the blade, and/or at a greater distance from the blade than the jets leaving the spray orifices. By way of nonlimiting example, at least one additional spray element 39 is arranged at a longitudinal end of the series of spray orifices 37 formed in the blade body 23, and this additional spray element 39 is configured to project the cleaning fluid in a direction away from jets leaving the spray orifices. In the example illustrated, two additional spray elements 39 are each arranged at a longitudinal end of the blade, being arranged in this way on either side of the series of spray orifices 37 formed in the blade body 23, and each of these additional spray elements 39 is configured to project the cleaning fluid in a direction away from the jets leaving the spray orifices, and thus also away from the jet leaving the other additional spray element. This makes it possible to spray and clean sensors which are arranged at ends of the window pillar, in zones Z1, Z3 which do not face the blade when the wiper device is in the second end-of-travel position. In this case, the particular longitudinal angular orientation of the additional spray elements is said to differ from the longitudinal angular orientation, substantially perpendicular to the blade, of the spray orifices forming the first spray means.

As will be described in greater detail with reference to FIG. 5, an additional spray element 39, here in the center of the blade, may have a longitudinal angular orientation similar to that of the spray orifices 37 of the series of spray orifices 37, that is to say an orientation perpendicular to the longitudinal direction of the blade, but differing from the mean orientation of the spray orifices 37 in that the vertical angular orientation is different, in particular in order to be able to project the cleaning fluid further onto the glazed surface and reach the window pillar when the blade is in the second end-of-travel position PF.

In the first embodiment, the additional spray elements 39 are arranged on the same circulation channel 35 as the spray orifices 37 of the series of spray orifices 37, with the result that the cleaning fluid circulating in this channel 35 is able to reach both the first spray means 21 and the second spray means 22. However, as mentioned above, the projection of cleaning fluid by the second spray means 22 takes place only upon approaching the window pillar 1, that is to say upon approaching the zones of sensors to be cleaned outside the visibility zone of the glazed surface, for reasons of cleaning fluid economy in particular.

Suitable means are used to achieve this functionality in this context. More particularly, a suitable control of the supply device 17, via the electronic management system 16, makes it possible to provide the cleaning fluid at different pressures according to the position of the wiper device. Up until reaching the second end-of-travel position PF, or a position close to this second end-of-travel position PF, the supply device 17 provides a cleaning fluid at a first pressure value. The first spray means are configured to allow the passage of fluid at this first pressure value, whereas the second spray means are configured to block the passage of fluid at this first pressure value.

By way of example, and as illustrated in FIG. 4 in particular, a passage cross section S1 of the spray orifices 37 of the series of spray orifices forming the first spray means is larger than a passage cross section S2 of each of the additional spray elements forming the second spray means.

Thus, when the cleaning fluid is at a first pressure value, the spray orifices 37 allow the projection of cleaning fluid, whereas the additional spray element 39, on account of its passage cross section being smaller than the passage cross section of the spray orifices of the series of spray orifices, cannot allow it. Only the visibility zone ZV receives cleaning fluid, via the spray orifices of the series of spray orifices 37 forming the first spray means 21.

When the supply device imposes a second pressure value on the cleaning fluid which is greater than the first pressure value, the spray orifices 37 of the series of spray orifices still allow the projection of cleaning fluid in front of the blade, in the visibility zone ZV, but the additional spray element 39 can now also project cleaning fluid, which then makes it possible to reach a zone outside the visibility zone.

The difference in passage cross section is one of the means which can be used to allow the blocking of the fluid by the second spray means up until reaching a position close to the end-of-travel position. By way of example, an alternative can be obtained by equipping the additional spray element with a valve configured to open only when, to return to the example described above, the supply device is controlled to provide in the blade a cleaning fluid at a pressure equivalent to the second pressure value mentioned.

FIG. 10 represents an alternative in which the additional spray element 39 comprises a closure element 63 configured to occupy a closure position, in which the closure element closes the passage cross section of the additional spray element at the first pressure value of the fluid, and an open position, in which the closure element is configured to at least partially free the passage cross section from the closure element at the second pressure of the fluid. Here, the closure element 63 is configured to pass from the closure position to the open position by clastic deformation.

In order to allow cleaning fluid to be projected into the appropriate zone, each spray orifice 37, as well as the additional spray elements 39, are formed in a tubular portion 34 of the blade body 23, so as to open out at one end into the cleaning fluid circulation channel, with a distinct orientation between the spray orifices forming the first spray means and the additional spray element(s) forming the second spray means. More particularly, the spray orifices 37 and the additional spray elements 39 may consist of holes drilled in the blade body 23 and delimited by material constituting the blade body 23.

The orientation of each of these spray orifices 37 is defined by an axis of elongation 370 and by the angle defined between this axis of elongation and a reference axis. More particularly, the longitudinal orientation of each of the spray orifices is defined by considering, in a plane substantially parallel to the glazed surface to be cleaned, or else in a longitudinal and transverse cutting plane of the blade, as illustrated in FIG. 3, the angle between the corresponding axis of elongation 370 and a straight line perpendicular to the longitudinal axis of the fluid circulation channel 35.

Moreover, the vertical orientation of each of the spray orifices is defined by considering, in a plane substantially perpendicular to the longitudinal elongation direction of the blade, that is to say in a longitudinal and transverse cutting plane of the blade, as illustrated in FIG. 4, the angle between the corresponding axis of elongation and a plane perpendicular to a straight line perpendicular to the longitudinal axis of the fluid circulation channel.

The axis of elongation 370 is defined as the axis passing through the center of the passage cross section at the junction of the spray orifice 37 and the circulation channel 35 and through the center of the passage cross section at the junction between the spray orifice 37 and the outer surface of the blade body 23. In the example illustrated, with spray orifices which are all formed by a hole in the thickness of the blade body, the axis of elongation 370 consists of an axis of revolution of the corresponding orifice.

The axes of elongation 370 of the spray orifices 37 forming the first spray means 21 are substantially parallel to one another and not coincident. From the respectively longitudinal and vertical angular orientation of all the axes of elongation 370 of the spray orifices 37, a mean respectively longitudinal and vertical orientation of the fluid spray orifices may be deduced, which may differ, where appropriate, by a few degrees or tenths of a degree from each of the axes of elongation to take account of manufacturing tolerances in particular.

For example, the at least one additional spray element 39, which forms the second spray elements 22 configured to project the cleaning fluid outside the visibility zone as mentioned above, so as to be able to clean an element arranged outside the visibility zone, is formed in the blade body 23 so as to have a longitudinal and/or vertical angular orientation different from the corresponding mean orientation of the spray orifices 37 forming the first spray means 21.

In particular, for the additional spray elements arranged at a longitudinal end of the blade, the difference in orientation may be relative to the longitudinal angular orientation of the various spray means. As can be seen in FIG. 4, a longitudinal separation angle α is formed between the axis of elongation 390 of an additional spray element 39 and the axis representative of the mean orientation of the axes of elongation 370 of the spray orifices 37. By way of nonlimiting example, this separation angle may be of the order of at least 10° so that the difference in orientation of the cleaning fluid jet via these additional spray elements is significant and makes it possible to reach zones Z1, Z3 of the window pillar for which the blade of the wiper device is not opposite.

For the additional spray elements arranged in the center of the blade, and in a complementary manner for these additional spray elements arranged at a longitudinal end of the blade, the difference in orientation may be relative to the vertical angular orientation of the different spray means, as will be described below with reference to FIGS. 6 and 7 in particular.

It should be noted that FIG. 4 is only a partial representation of the longitudinal dimension of the body of the blade and that other spray orifices may be present, and that also other additional spray elements may be present. As can be seen in FIG. 3 in particular, by the representation which has been made of the projection of cleaning fluid outside the visibility zone in the direction of sensors arranged on the window pillar, the wiper device advantageously comprises a plurality of additional spray elements arranged on the blade body and distributed along the longitudinal axis of the wiper blade. These additional spray elements may have longitudinal and/or vertical angular orientations which are the same from one additional spray element to another, or which, on the contrary, vary according to their position on the blade in order to reach a particular zone on a window pillar, provided that each additional spray element has, according to the invention, an orientation different from the mean orientation of the spray orifices forming the first spray means.

FIG. 5 illustrates a view in section, in a vertical and transverse plane, perpendicular to the longitudinal elongation direction of the blade, of a first embodiment of the wiper device as has just been mentioned, with the first spray means and the second spray means which are arranged in the same circulation channel, the view in section allowing only one spray orifice to be seen.

FIG. 6 illustrates a second embodiment, which differs from the foregoing in that the blade body 23 comprises, in addition to the tubular portion 34 described above, an additional tubular portion 34′ which delimits an additional circulation channel 35′ within it, and in which the at least one additional spray element 39 forming the second spray means 22 is formed in this additional tubular portion 34′.

In a manner similar to that described for the tubular portion 34, the additional tubular portion 34′ is connected to the supply device 17, so that each of the circulation channels 35, 35′ can be supplied with cleaning fluid. When cleaning fluid circulates in the tubular portion 34 and its circulation channel 35, the cleaning fluid is able to leave via the spray orifices forming the first spray means 21. When cleaning fluid circulates in the additional tubular portion 34′ and its additional circulation channel 35′, the cleaning fluid is able to leave via the additional spray element(s) forming the second spray means 22, it being understood that each additional spray element 39 is in fluidic communication with the additional circulation channel 35′. The circulation channel and the additional circulation channel are at least partially formed in the projection of the deflector. Here, the circulation channel and the additional circulation channel are aligned in the vertical direction.

It should be noted that this FIG. 5 makes it possible to illustrate the feature according to which the vertical angular orientation of the additional spray elements, forming the second spray means, is different from that of the spray orifices forming the first spray means. This feature is represented here in the context of two circulation channels in parallel, in order to case understanding by the reader in one and the same section plane, but it should be noted that the feature of different vertical angular orientation between the first and second spray means, as has been described in the first embodiment, may be understood in the light of what is represented here.

Very particularly, whatever the embodiment, at least one additional spray element may have a vertical angular orientation different from that of the spray orifices forming the first spray means, seen in a transverse and vertical plane perpendicular to the longitudinal direction of the blade of the wiper device.

As can be seen in FIG. 6, a vertical separation angle β is formed between the axis of elongation 390 of an additional spray element 39 and the axis representative of the mean orientation of the axes of elongation 370 of the spray orifices 37. By way of nonlimiting example, this separation angle may be of the order of at least 10° so that the difference in orientation of the cleaning fluid jet via these additional spray elements is significant and makes it possible to reach zones Z1 to Z3 of the window pillar which are distant from the blade of the wiper device when the latter is in the second end-of-travel position.

Moreover, in the illustration of this embodiment, as for the previous one, the tubular portion and the various spray means are formed in the air-deflecting element 33; however, it should be recalled that these components of the invention could be formed with the same result in the rubber support, provided that they are formed in the deflector, between the end pieces.

The advantage of such a second embodiment is illustrated in particular in FIG. 7. In accordance with what has been described above, it is desirable according to the invention to trigger the projection of cleaning fluid by the second spray means only when approaching the window pillar and the zones comprising the sensors, in order to avoid wasting cleaning fluid. Advantageously, the second spray means are supplied by a circulation of fluid within the additional circulation channel, and therefore separately from the circulation channel 35 and from the first spray means 21. Provided that the device is equipped with a valve (not shown here) or an equivalent device allowing the cleaning fluid to be selectively directed toward one and/or the other of the circulation channel and of the additional circulation channel, the electronic management system 16 and the supply device 17 can cut off the supply of cleaning fluid via the first spray means 21 at the moment of projection via the second spray means 22.

In this context, and as can be seen in FIG. 7, an additional projection position PA can be provided, beyond the second end-of-travel position PF, which makes it possible to bring the second spray means closer to the window pillar 1 and to the sensor zones 5 to be sprayed, and the projection of fluid by the first spray means can advantageously be cut off in this additional projection position, since the cleaning fluid which would be projected by these first spray means would be unnecessary because it is not in a useful zone of the glazed surface and does not reach the window pillar and the sensors.

The invention, as it has just been described, clearly achieves the aim it had set itself, and makes it possible to propose a wiper device which combines spray means intended for cleaning a glazed surface of the motor vehicle and spray means intended for cleaning sensors installed in a window pillar bordering this glazed surface. Variants not described here could be implemented without departing from the context of the invention, provided that, in accordance with the invention, they comprise spray means whose orientation within the body of the blade makes it possible to generate these different projection zones, namely a zone of the glazed surface directly upstream of the blade and intended to be wiped by the blade of the wiper device, and a zone on or in the vicinity of the window pillar.

1. A wiper blade comprising:
a blade body extending along a longitudinal elongation direction of the wiper blade, and
a wiper rubber carried by the blade body and configured for cleaning a visibility zone of a glazed surface for a motor vehicle,
the blade body comprising:
at least one spray element configured to project the cleaning fluid into an additional zone separate from the visibility zone to clean an element arranged outside the visibility zone,
wherein the at least one spray element is in a so-called vertical orientation defined by an angle between 60° and 110° with respect to a so-called vertical direction substantially perpendicular to the longitudinal elongation direction and in a so-called vertical plane, of which the normal is parallel to the main elongation direction.

2. The wiper blade as claimed in claim 1,
wherein the angle defining the vertical orientation is between 60° and 100°.

3. The wiper blade as claimed in claim 1,
wherein the angle defining the vertical orientation is between 80° and 100°.

4. The wiper blade as claimed in claim 1,
wherein the angle defining the vertical orientation is between 70° and 90°.

5. The wiper blade as claimed in claim 1,
wherein the blade comprises at least one spray orifice configured to project the cleaning fluid substantially into the visibility zone.

6. The wiper blade as claimed in claim 5,
wherein the at least one spray orifice is in a vertical orientation different from the vertical orientation of the at least one so-called additional spray element.

7. The wiper blade as claimed in claim 5,
wherein a vertical separation angle between the vertical orientation of the at least one spray orifice and the at least one additional spray element is at least 10°.

8. The wiper blade as claimed in claim 1,
wherein the orientation of the at least one spray orifice differs from the orientation of the at least one additional spray element seen in projection on a plane perpendicular to a longitudinal median plane of the wiper rubber and comprising the longitudinal elongation direction of the wiper blade.

9. The wiper blade as claimed in claim 1,
wherein a mean passage cross section of the at least one spray orifice of the series of spray orifices is larger than a passage cross section of the additional spray element.

10. A device for wiping a glazed surface for a motor vehicle, the device comprising:
at least one wiper blade for wiping the glazed surface as claimed in claim 1,
wherein the at least one spray orifice is configured to project the cleaning fluid into the visibility zone formed by the cleaning zone of the wiper rubber, and
wherein the at least one additional spray element is configured to project the cleaning fluid outside the visibility zone of the wiper rubber so as to permit the cleaning of at least one element arranged outside the visibility zone.
